(19) United States
(12) Patent Application Publication
(10) Pub. No.: US 2021/0019781 A1
(43) Pub. Date: Jan. 21, 2021

(54) OMNICHANNEL MULTIVARIATE TESTING PLATFORM

(71) Applicant: Target Brands, Inc., Minneapolis, MN (US)

(72) Inventors: GURUDEV KARANTH, Sunnyvale, CA (US); MICHAEL JANTSCHER, Minneapolis, MN (US); ARI E. OLSON, Minneapolis, MN (US); DEREK OLK, Minneapolis, MN (US); SAURABH DHUPAR, San Jose, CA (US); MITHUN YARLAGADDA, San Jose, CA (US)

(21) Appl. No.: 16/516,877

(22) Filed: Jul. 19, 2019

(51) Int. Cl. G06Q 30/02

(52) U.S. Cl. CPC G06Q 30/0243; G06Q 30/0246

(57) ABSTRACT

A multivariate testing platform is disclosed. The platform includes a test definition environment including a test deployment and data collection interface configured to (1) manage test deployments within a retail environment to a controlled subset of users across a plurality of content delivery channels, and (2) receive test data from an analytics server regarding user interaction regarding the test deployment. The test definition environment includes a self-service test definition and analysis tool configured to generate a user interface accessible by enterprise users, the user interface including a test definition interface useable to define a test selectable from among a plurality of test types and an analysis interface graphically displaying test results based on the test data from the analytics server.

### BACKGROUND

Multivariate, or AB testing, is a common way to compare performance of different versions of products or services in circumstances where those products or services are offered in high volume two large populations. In some cases, retailers will use multivariate testing regarding the way in which products are presented to customers and will assess the effects of presenting products in a particular way as a function of sales performance. For example, an online retailer may present a particular product in a prominent location on that retailer's website, and will assess the effect (if any) of the prominent positioning of the product on sales performance.

Although various systems exist for performing multivariate testing, these systems have limitations with respect to the types of tests and the breadth of testing subjects that can be addressed. For example, a change to a retailer web site can be introduced, and a performance effect of that change can be assessed regarding the online sales of various products in response to that change. However, existing multivariate testing systems are inadequate at determining effects of such changes on other portions of the retailer's business. For example, although a change to the retailer web site may change a sales rate of one or more products from the retailer web site, that change may also result in changes to sales rate those products (or different products) at physical store locations associated with the retailer.

Furthermore, such existing multivariate testing systems may require significant test configuration efforts that are not readily accessible by marketing personnel, web developers, or others who may wish to test various product offerings, website configurations, or other types of changes to retail offerings. For example, the manner and mechanisms by which a test group and control group are selected, how concurrent tests are managed, control of different content delivery channels, and other features may not even be accessible to those wishing to conduct such tests. Still further, even if a testing system were available, that system may not be readily useable within the context of retailer's “live” operations, and therefore the utility of such testing (which may instead be considered hypothetical at best) may be limited.

Therefore, improvements in the manner in which multivariate testing is performed and assessed are desirable.

### SUMMARY

In general, the present disclosure relates to methods and systems for performing multivariate (AB) testing. A self-service tool is provided that allows users to select various channels within which such testing can be performed. In the context of a retail application, the channels may include, e.g., an in-person (point-of sale) channel, a website channel, or an application-based channel. Various metrics can be assessed in that context, such as store, web, or application traffic, sales, or interest in specific items. Tests can be managed and deployed in realtime to selected sets of retail customers, and analytics generated from customer interactions with online or physical retail locations. Tests are managed so that users can be tracked either uniquely or in approximation to determine effects across sales channels.

In a first aspect, a multivariate testing platform is disclosed. The platform includes a test definition environment including a test deployment and data collection interface configured to manage test deployments within a retail environment to a controlled subset of users across a plurality of content delivery channels, and receive test data from an analytics server regarding user interaction regarding the test deployment. The test definition environment includes a self-service test definition and analysis tool configured to generate a user interface accessible by enterprise users, the user interface including a test definition interface useable to define a test selectable from among a plurality of test types and an analysis interface graphically displaying test results based on the test data from the analytics server. The test results attribute at least a portion of sales lift to two or more content delivery channels and being associated with a set of test subjects, the test subjects tracked across the two or more content delivery channels.

In a second aspect, a method of executing a multivariate test within a retail environment is disclosed. The method includes receiving, from a first user, a definition of a proposed test via a self-service test definition and analysis tool of a multivariate testing platform, the definition of the proposed test including a proposed change to one or more of: a product offering, a product display, an advertisement, or a digital content distribution, the definition including a selection of a duration and one or more content delivery channels from among a plurality of available content delivery channels. The method further includes, upon acceptance of the proposed test, activating the proposed test for the duration by providing the proposed change to a test group and withholding the proposed change from a control group, wherein the activated proposed test is provided in realtime within current retailer commercial offerings. The method also includes generating a graphical illustration accessible by the first user via the self-service test definition and analysis tool of test results. The test results attribute at least a portion of sales lift to two or more content delivery channels and being associated with a set of test subjects, the test subjects tracked across the two or more content delivery channels.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an environment in which aspects of the present disclosure can be implemented.

FIG. 2 illustrates an example method for omnichannel multivariate testing according to aspects of the present disclosure.

FIG. 3 illustrates an example multivariate testing platform useable to perform omnichannel multivariate testing.

FIG. 4 illustrates a multivariate testing lifecycle implemented using the platform of FIG. 3.

FIG. 5 is a schematic user interface of a self-service test definition and analysis tool useable within the context of the multivariate testing platform described herein.

FIG. 6 is a further schematic user interface of the self-service test definition and analysis tool of FIG. 5.

FIG. 7 is a further schematic user interface of the self-service test definition and analysis tool of FIG. 5.

FIG. 8 is a further schematic user interface of the self-service test definition and analysis tool of FIG. 5.

FIG. 9 is a further schematic user interface of the self-service test definition and analysis tool of FIG. 5.

FIG. 10 is a further schematic user interface of the self-service test definition and analysis tool of FIG. 5.

FIG. 11 illustrates an example computing system with which aspects of the present disclosure can be implemented.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As briefly described above, embodiments of the present invention are directed to an omnichannel multivariate testing platform and an associated self-service test definition and analysis tool. According to example aspects of the present disclosure, a testing platform is provided that allows non-technical users to define and manage tests, and to view results of tests within an analysis tool, by managing user interactivity and test submission. Still further, the testing platform defines the contribution of the test to performance across a plurality of channels of interactivity with users. In the context of a retail application, the channels may include, e.g., an in-person (point-of sale) channel, a website channel, or an application-based channel. Various metrics can be assessed in that context, such as store, web, or application traffic, sales, or interest in specific items (e.g., clicks, views, or other metrics acting as a proxy for user interest). Tests can be managed and deployed in realtime to selected sets of retail customers, and analytics generated from customer interactions with online or physical retail locations.

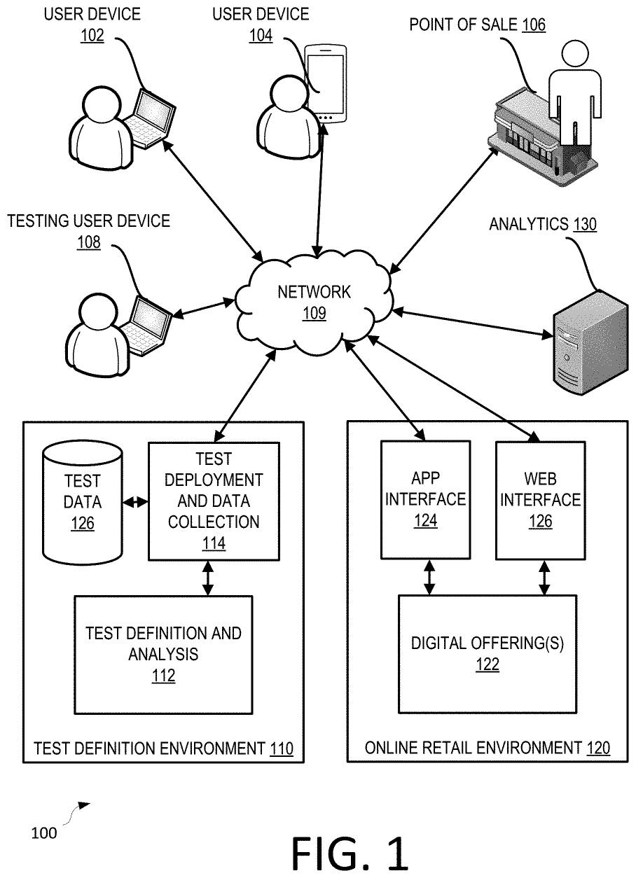

Referring to FIG. 1, an environment 100 is illustrated in which aspects of the present disclosure can be implemented. As shown, the environment 100 includes a test definition environment 110 that is in communication with an online retail environment 120. The online retail environment 120 is accessible from any of a plurality of user channels, such as a web site, a mobile application, or a point of sale. As seen in FIG. 1, each of user device 102, user device 104, and point of sale 106 can be used to access the online retail environment 120, e.g., via network 109 (such as the Internet). For example, the point of sale 106 may be in communication with the online retail environment 120 for purposes of exchanging information relating to products or services offered by the retailer, while the user device 102 and user device 104 may directly access the online retail environment 120 for purposes of access or purchase of goods and services.

In the embodiment shown, the online retail environment 120 provides a plurality of digital offerings 122. The digital offerings 122 can be accessible via an application interface 124 or a web interface 126. The application interface 124 may be accessible for example from user device 104, while the web interface 126 may be accessible via a web browser on any of a variety of computing devices, such as user device 102 or user device 104.

In the embodiment shown, an analytics server 130 gathers data relating to interactions between users and the point of sale 106 and/or the online retail environment 120. For example, in some embodiments the analytics server 130 receives click strain data from user devices 102, 104 based on interactions with the online retail environment 120.

In the context of environment 100, it is noted that different users may view the digital offerings 122 of the online retail environment 120 differently depending upon the time at which the digital offerings 122 are viewed, and the device from which those digital offerings are viewed. Accordingly, a user may interact differently with the digital offerings depending upon that user's experience. Similarly, a user may interact differently with an item or advertisement at a point of sale 106 depending upon how that item or advertisement is presented to the user. Accordingly, a test definition environment 110 may be used to deploy tests within the environment 100 to determine ways in which digital or physical offerings may be presented to users with improved effectiveness.

In the embodiment shown, a testing user device 108 may be operated by an employee or contractor of the retailer who wishes to change one or more aspects of the user experience for users visiting the retailer (either in person, or via digital means). The testing user device 108 may have access the test definition environment 110 and use a test definition and analysis tool 112 to define a proposed test for application by the retailer. The test definition and analysis tool 112 also provides an analysis user interface to the user of the testing user device 108 four purposes of presenting to that user experimental results from the proposed test. In the example shown, test data 126 is received by the test definition environment 110, and can be, for example, from the analytics server 130.

In operation, although single users are displayed at user devices 102, 104 and at point of sale 106, it is a recognized that a large number of users may be accessing the online retail environment 120 or point of sale 106 at any given time. Accordingly, it is possible that, depending on the test to be performed and selected set of users against which the test is assessed, more than the one proposed test may be made to live at a time. A test deployment and data collection interface 114 manages communication between the test definition environment 110 and the analytics server 130, the online retail environment 120, the point of sale 106, and the testing user device 108 to ensure that tests performed are coordinated such that results of one test do not affect results of another test occurring concurrently. In particular, tests determined to be “orthogonal” to one another would not affect one another (e.g., by affecting different parts of a website, or other manners of separation). By overlapping orthogonal tests on the same day or days, testing frequency can be increased.

In accordance with the present disclosure, tests can be provided to specific users to ensure random sampling and to ensure that the test does not interfere with other tests that are to be run concurrently. Once complete, automated analysis can be performed such that decisions can be reached. Also, a deeper dive can be taken manually into the test results. A guest snapshot can be created based on the tests. Additionally, a testing user (e.g., a user of a testing user device 108) can select from among the types of tests supported—e.g., a test of visitors, logged-in users, targeted users, geographically local users, or other types of test segments.

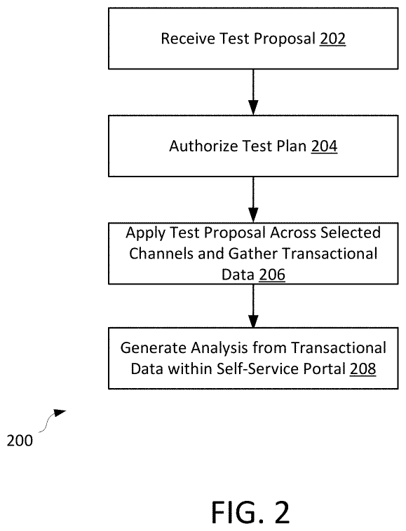

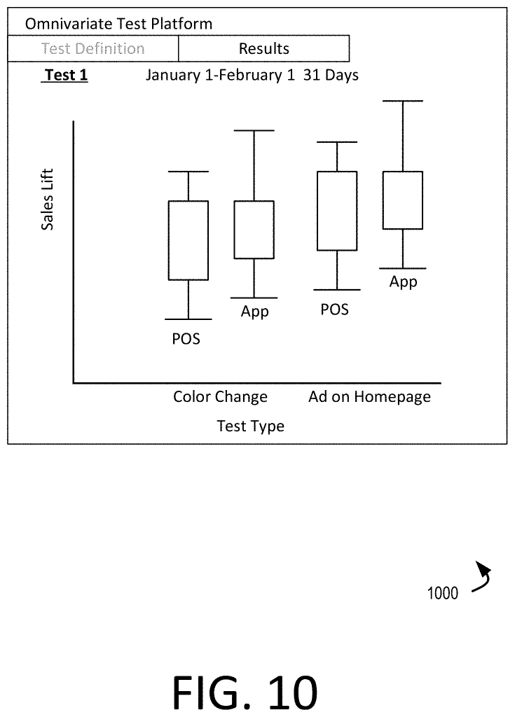

Referring now to FIG. 2, a method 200 is shown for omnichannel multivariate testing according to aspects of the present disclosure. The method 200 can be performed, for example, within the environment 100 depicted in FIG. 1, and using any of a variety of computing devices or systems, such as those described below in connection with FIG. 10.

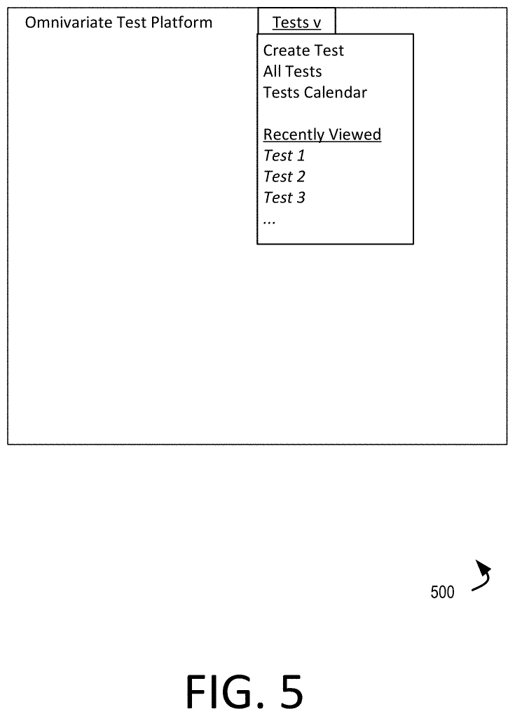

In the embodiment shown, the method 200 includes receiving a test proposal (at 202). The test proposal can be received, for sample, from a test user such as test user device 108 of FIG. 1. The test proposal can include, for example, a duration, a proposed change, a definition of a user population to whom the test should be applied, and one or more channels within which the test should be applied or results should be analyzed. In a particular embodiment, the test proposal is received in a self-service testing user interface exposed by the tests definition environment 110. An example of such a user interface is described in further detail below in connection with FIGS. 5-10.

In various examples, proposed tests can take different forms, depending upon the channel in which the test will affect users. For example, proposed tests may be simple online tests such as changing a color, or changing icons. However, the proposed test could have more drastic impact, such as changing a search algorithm. Within the context of an in-store change, tests could include, for example changes to a planogram of the store, changes to sets of items, mixes of items, or supply chain methodologies, by way of example.

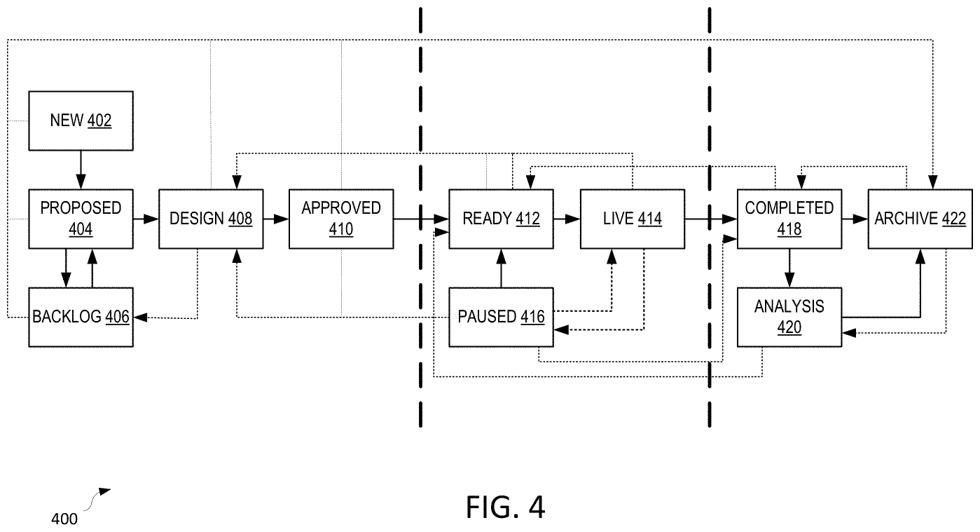

In the embodiment shown, the method 200 also includes authorizing a test plan (at 204). Authorizing the test plan can include receiving approval of the test plan from one or more other divisions within an enterprise, implementing a change to a digital or physical presentation of products or services in accordance with the test plan, defining user groups to whom the test should be presented, etc. In example embodiments, each test proposal or plan is assigned a state from among a plurality of predefined test states. The test states can define a life cycle of a particular test. An example illustration of the test states used within the environment 100 is provided below in connection with FIG. 4.

In the embodiment shown, the method 200 further includes applying the test proposal across the one or more channels selected in the test proposal and gathering transactional data reflective of execution of the test defined by the test proposal (at 206). Applying the test proposal can include selecting and overall set of users to be included in a test, and defining the proportion of those users that will be exposed to the proposed tests, as compared to the remainder of users who will be used as a control group. Applying the test proposal can also include gathering feedback regarding the test at an analytics server such as analytics server 130, and providing that feedback in the form of test data to the test definition environment 110.

The test proposal that can be applied may take any of a variety of forms. For example, various tests may be used to determine sales lift for a particular change to user experience. Such tests include: a pre-post test, which determines a change in sales lift before and after a change; a coin flip as to whether a user experiences a change; a session-based test, where each test is consistently applied (or not applied) within a particular browser session; a visitor test, which uses cookies to ensure that the same user has a consistent experience (e.g., either being presented the test experience or the control experience consistently) and therefore avoids artificially inflated data that may arise from repeated visits by a same user; a cohort/targeted test that is defined to be applied to a particular audience; or a geographically-defined test, which applies a proposed test to users within a particular geographic location. In some instances, more than one test type may be applied.

In addition, applying the tests proposal involves determining, from among the selected users to be included in a test, how to split traffic such that only a portion of the selected users will be presented the test experience while all other users are presented the control experience in order to determine sales lift. While in some embodiments the user defining the test may select how traffic should be split, in other embodiments the platform 100 will randomize the users or sessions in which the test experience is provided.

It is noted that in accordance with the present disclosure, since traffic will be apportioned to particular users, those users will be tracked to determine whether a change occurring in one channel may affect that user in a different channel. Accordingly, each user is assigned a global identifier for purposes of testing, which may be linked to either known data relating to the user (if the user is known to the retailer) or may be based on, e.g., an IP address and other unique characteristics of the user, if that user is online. Example methodologies for tracking users across different digital devices (e.g., between a first device on which a web channel is used and a second device on which an application is used) are provided in U.S. patent application Ser. No. 15/814,167, entitled “Similarity Learning-Based Device Attribution”, the disclosure of which is hereby incorporated by reference in its entirety. Still further, in-store users can be tracked based on use of a known payment method which may be linked to a user account, thereby allowing the user to be linked between physical and digital sales channels. Alternately, users who visit a store with a mobile device having an application installed thereon may be detectable, and therefore in-store and application or web activities linked together. Other methods of either uniquely or pseudo-uniquely identifying a physical use through some combination of behavior-based modeling, geographical location similarity between a store visit and an IP address of a device having a digital channel interaction, or other methods may be used as well.

In the embodiment shown, the method 200 additionally includes generating analysis from the transactional data within the self-service testing user interface (at 208). The analysis can take a variety of forms. For example in some embodiments overall sales lift can be analyzed, with a portion of the sales with attributable to the test proposal being identified to the user. This can be accomplished, for example, using a regression analysis, and optionally also utilizing a Kalman smoother to reduce the effects of outliers on overall results. Additional details regarding other types of analyses are described below.

In example implementations, various units of analysis may be presented to the user. For example, item level or visitor level effects on demand (sales lift) can be presented (e.g., to determine total transactions and units). Additionally, a per-store per-week or per-store per day analysis could be used as well (e.g., to determine demand sales, or effects on supply chain). Transaction/order level or guest/user level analysis can be provided as well (e.g., to determine average over value, demand sales, total transactions, etc.).

Additionally, in some embodiments, the method 200 includes identifying and removing one or more outliers from the test data obtained from the analytics server 130. In the context of the present disclosure, an outlier corresponds to an observation that is significantly different from other observations, for example due to variability in message for experimental error. In the case an outlier is identified, that outlier can be replaced by a data point that is better fitting to the data set or can simply be eliminated. Additionally, in some instances, rather than using the test data directly the analysis tools of the present disclosure assess sales lift based on lognormal distribution, which reduces the effect of such outliers. Other approaches may be adopted as well.

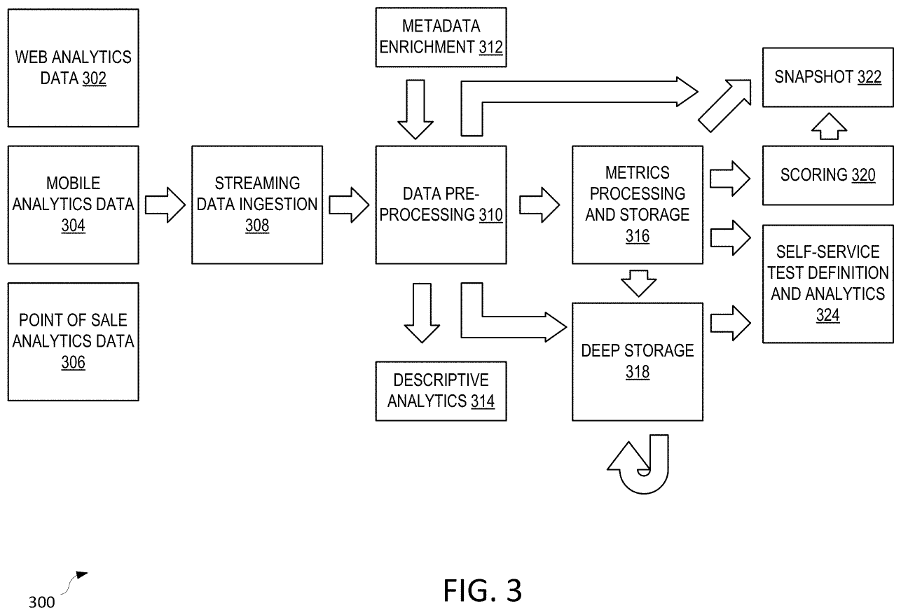

FIG. 3 illustrates an example multivariate testing platform 300 useable to perform omnichannel multivariate testing. The multivariate testing platform 300 seen in FIG. 3 can be utilized, for example, to implement the test definition environment 110 of FIG. 1.

In the embodiment shown, data from each of a plurality of channels can be received for purposes of analysis. For example, web analytics data 302, mobile analytics data 304, and point of sale analytics data 306 can be received at a streaming data ingestion service 308. In each of these data sets represents streaming data associated with user interactions that are attributable to respective communication channels (web, app, point of sale). The streaming data ingestion service 308 can be implemented, for example, using a Kafka streaming data service provided by the Apache Software Foundation.

Within the multivariate testing platform 300, the data received via the streaming data ingestion service 308 can be provided to a preprocessing module 310. The preprocessing module 310 can, in some embodiments, enrich the received data with metadata that assists in data analysis. Such metadata can include, for example, a source of the data, a particular test identifier that will be associated with the data for purposes of analysis, a test group associated with the user interaction described by the data, or other additional descriptive features. The preprocessed data can then be provided to, for example, a descriptive analytics tool 314 and a metrics processing engine 316.

The descriptive analytics tool 314 can be used to search and extract relevant data for purposes of generating test metrics. For example, the descriptive analytics tool 314 can be implemented using the Elasticsearch search engine. The metrics processing engine 316 is configured to generate one or more comparative metrics relating to the test data and how that test data compares to other observed data captured by the analytics server 130. The metrics processing engine 316 may utilize deep storage 318, which may store historical performance data relevant to the test being performed. In the example illustrated, the deep storage 318 can be periodically enriched using offline data resources, such as any additional information which may explain change is in user behavior or sales performance (e.g., Whether abnormalities, natural disasters, seasonality, store closure or other business interruption, etc.).

In the embodiment shown, the metrics processing engine 316 provides comparative analysis data to a scoring module 320 and a self-service testing user interface 324. The scoring module 320 is configured to generate a score of the executed test that can be consumed by various users for purposes of assessing effectiveness of the proposed (and now executed) test. A snapshot tool 322 can generate a graphical snapshot of comparative performance based on data from the metrics processing engine 316 and scoring module 320.

The self-service testing user interface 324 exposes a user interface to a testing user (e.g., an employee of the retailer/enterprise who wishes to design a test for execution, such as a user of a testing user device 108 as in FIG. 1). The testing user interface allows the user to define a proposed test, while an analytics component presents to that user in interactive user interface for reviewing results of the test once executed. In example embodiments, the analytics component presents a user interface that includes an analysis of overall sales lift, as well as sales lift that can be apportioned to the test that is executed. In such instances, a confidence interval may be presented that reflects a confidence level (with lower and upper bounds) on the range of sales lift that can be apportioned to the test. In example embodiments, lower and upper bounds for the confidence interval can be defined differently for digital (app and web) tests and in-person (point of sale) tests. In some examples, in person tests may utilize a T test or Wilcoxon test for purposes of determining a confidence interval. However, other methodologies might be used as well.

Referring now to FIG. 4, a multivariate testing lifecycle 400 is shown, if implemented using the platform 300 of FIG. 3. In general, the test and less civil 400 includes a management phase, an execution phase, and a learning phase. Within the management phase, a test may be assigned any of a plurality of states including a new state 402, a proposed state 404, a backlog state 406, a design state 408, or an approved state 410. In the new state 402, a test is created by a user such as a product team member. In the proposed state 404, the user submits the experiment to a testing team. The submitted experiment may they moved to the backlog state 406, where the test team may have rejected or delayed the test proposal with an explanation of corrections that are required. Once the submitted experiment is accepted, it passes to a design state 408, and ultimately to an approved state 410 once the test has passed quality assurance and platform testing processes, and a traffic apportionment is assigned.

The experiment, or test, passes to the ready state 412 where a traffic manager allots traffic spectrum to the test (e.g., between the test and control groups). They experiment continues to a live state 414, and it is executed. In some instances, the experiment will be paused, and therefore enter a paused state 416. Otherwise, the experiment will execute to completion (e.g., until its defined duration is reached) and enter a completed state 418. The experiment will no longer be published at this point. The experiment can then pass to an analysis state 420, in which a product team or other testing user can perform analysis of resulting test data. They experiment can be assigned an archived state 422 based on completion of analysis or completion of the test.

Referring now to FIGS. 5-10, an example is shown of a self-service testing user interface, according to example embodiments. The self-service testing user interface can be generated, e.g., by the test definition environment 110.

FIG. 5 is a schematic user interface 500 of a self-service test definition and analysis tool useable within the context of the multivariate testing platform described herein. In the embodiment shown, the user interface 500 includes a tests menu that stores a list of historical tests that were run for purposes of recalling to view analysis and/or test proposals for those tests. Additionally, the tests menu includes a create test option, an all tests option, and a tests calendar option. Generally, the create test option will be described further below, but allows a testing user (typically, a non-technical user who is a member of a product or web development team) to propose a test to be executed. The all tests option allows the user to view the possible set of tests that can be run. As noted above, such tests include: a pre-post test; a coin flip; a session-based test; a visitor test; a cohort/targeted test; or a geographically-defined test. In some instances, more than one test type may be applied. Additionally, a tests calendar option displays a calendar view with other approved and scheduled tests appearing, so that the testing user can select a particular set of dates on which they may propose to run a test that might not conflict with tests run for the same/similar user populations. Or, the user may wish to ensure that two tests either partially or completely overlap in time to see the effect of the combined tests.

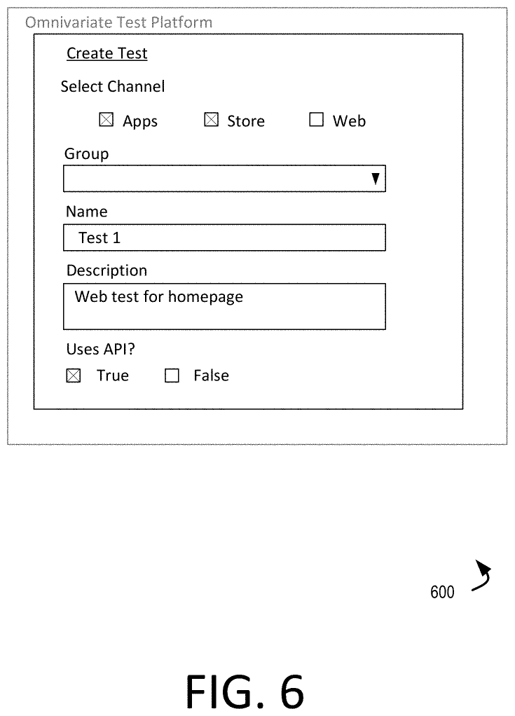

FIG. 6 is a further schematic user interface 600 of the self-service test definition and analysis tool of FIG. 5. The user interface 600 can be displayed, for example, once the create test option is selected in the user interface 500 of FIG. 5. In the example shown, a test creation window is displayed in which a user may select one or more channels of a multi-channel multivariate test associated with the retailer. In the example shown, the tests are selected from among a test of applications, in-store (point-of-sale), and web channels. A group selection allows a user to select a particular type of group of individuals to which the test is applied; example individuals to be tested include, e.g., visitors, logged-in users, targeted users, geographically local users, or other types of test segments. The user may assign a name to the test, as well as a description for the test. The user may also define whether to use an API for testing, e.g., for purposes of connecting to data gathering systems for web or application tests.

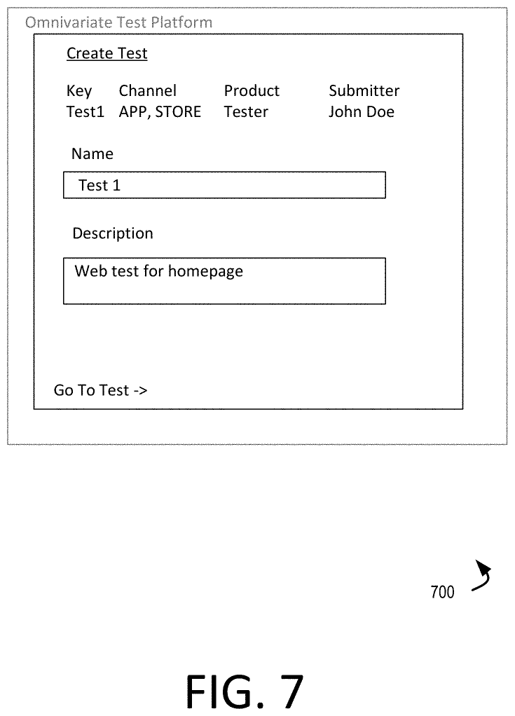

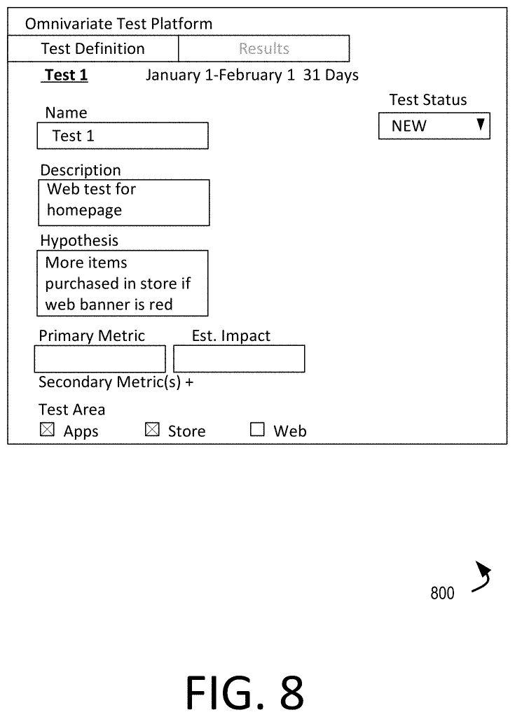

FIG. 7 is a further schematic user interface 700 of the self-service test definition and analysis tool. In this example user interface 700, the test defined using the user interface 600 of FIG. 6 is listed, and named. The user interface may also be reached via selection of a past test as seen in FIG. 5. In the example shown, the user can select “go to test” to view details regarding the test definition, leading to user interface 800 of FIG. 8. In that user interface 800, additional test definition may be provided by a user. In this example, the test may have a selectable status from among the states identified in FIG. 4 (as limited by the rights of a particular user to change the status of the test). The test may also identify a duration, name, and description of a test, as well as a possibly hypothesis to be proved, as well as metrics and estimated impact for such metrics. Selection of specific channels for the test can be made or modified in the user interface 800 as well.

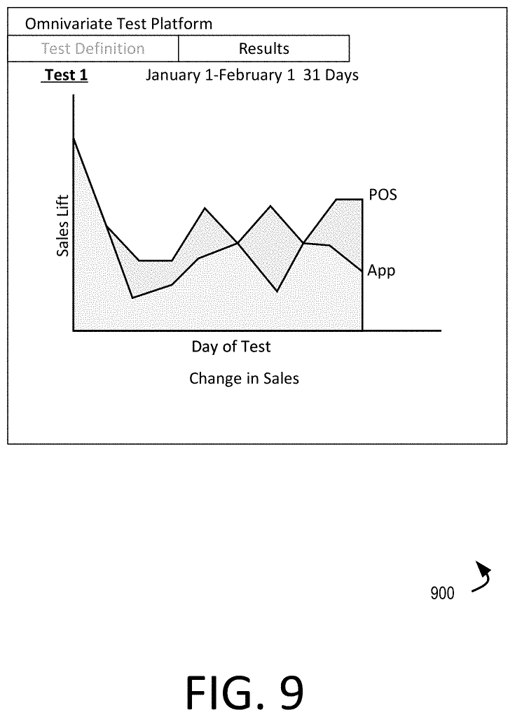

FIGS. 9-10 represent user interfaces 900, 1000 that may provide analysis to a user following execution of a test. User interface 900 depicts a test and shows raw data associated with sales lift in point of sale and application based interactions with users. The sales lift can be defined as a percentage increase in sales over a baseline of control users, across each day of the test. By way of comparison, user interface 1000 depicts a calculated range of sales lift attributable to the particular test that is performed, as well as a confidence range for attribution (e.g., in the event of outliers or sparse data). Additionally, the user interface 1000 depicts two orthogonal tests (depicted as “color change” and “ad on homepage”) performed concurrently on different portions of an application or website, with separate sales lift depicted. Such analysis can be achieved via a regression analysis of the interaction data, with confidence intervals being calculated in a variety of ways (as described briefly above), and possibly calculated differently for digital and in-person interactions.

It is noted that although FIGS. 9-10 depict sample analysis, a wide variety of additional analyses could be provided as well. In example embodiments, sales lift, actual, and normalized values are each provided and can be navigated to and viewed. Additionally, even with the visualizations provided above (e.g., using confidence ranges) various types of metrics can be tracked, such as demand sales, average order value, or likelihood of visitor with purchases. Accordingly, a user must be tracked across channels to assess the effect of a change in one channel on purchases in another.

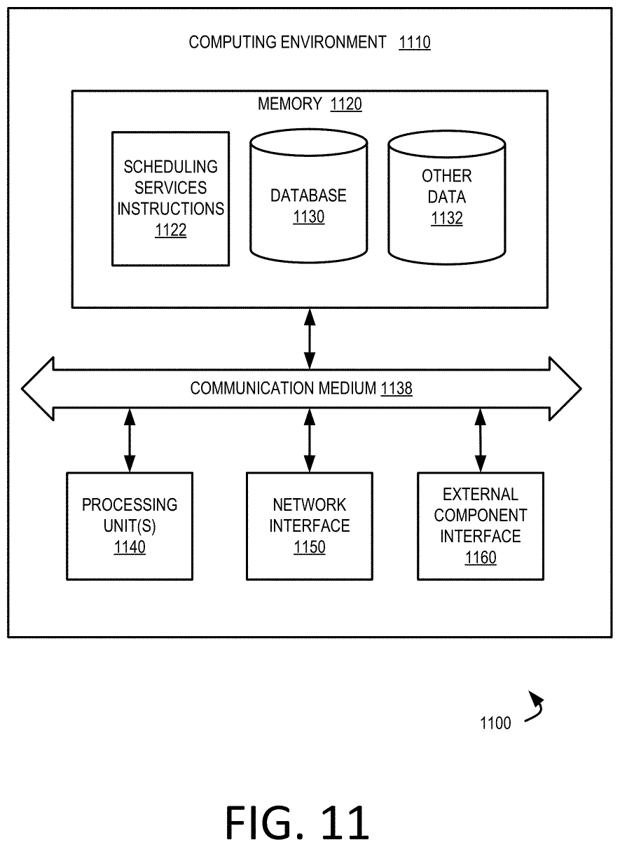

FIG. 11 illustrates an example system 1100 with which disclosed systems and methods can be used. In an example, the system 1100 can include a computing environment 1110, and can be used to implement any of the computing devices described above. The computing environment 1110 can be a physical computing environment, a virtualized computing environment, or a combination thereof. The computing environment 1110 can include memory 1120, a communication medium 1138, one or more processing units 1140, a network interface 1150, and an external component interface 1160.

The memory 1120 can include a computer readable storage medium. The computer storage medium can be a device or article of manufacture that stores data and/or computer-executable instructions. The memory 1120 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. Computer storage media does not include a carrier wave or other propagated or modulated data signal. In some embodiments, the computer storage media includes at least some tangible features; in many embodiments, the computer storage media includes entirely non-transitory components.

The memory 1120 can store various types of data and software. For example, as illustrated, the memory 1120 includes synchronization instructions 1122 for implementing one or more aspects of the data synchronization services described herein, database 1130, as well as other data 1132. In some examples the memory 1120 can include instructions for managing storage of transactional data, such as web interactivity data in an analytics server.

The communication medium 1138 can facilitate communication among the components of the computing environment 1110. In an example, the communication medium 1138 can facilitate communication among the memory 1120, the one or more processing units 1140, the network interface 1150, and the external component interface 1160. The communications medium 1138 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 1140 can include physical or virtual units that selectively execute software instructions. In an example, the one or more processing units 1140 can be physical products comprising one or more integrated circuits. The one or more processing units 1140 can be implemented as one or more processing cores. In another example, one or more processing units 1140 are implemented as one or more separate microprocessors. In yet another example embodiment, the one or more processing units 1140 can include an application-specific integrated circuit (ASIC) that provides specific functionality. In yet another example, the one or more processing units 1140 provide specific functionality by using an ASIC and by executing computer-executable instructions.

The network interface 1150 enables the computing environment 1110 to send and receive data from a communication network (e.g., network 140). The network interface 1150 can be implemented as an Ethernet interface, a token-ring network interface, a fiber optic network interface, a wireless network interface (e.g., WI-FI), or another type of network interface.

The external component interface 1160 enables the computing environment 1110 to communicate with external devices. For example, the external component interface 1160 can be a USB interface, Thunderbolt interface, a Lightning interface, a serial port interface, a parallel port interface, a PS/2 interface, and/or another type of interface that enables the computing environment 1110 to communicate with external devices. In various embodiments, the external component interface 1160 enables the computing environment 1110 to communicate with various external components, such as external storage devices, input devices, speakers, modems, media player docks, other computing devices, scanners, digital cameras, and fingerprint readers.

Although illustrated as being components of a single computing environment 1110, the components of the computing environment 1110 can be spread across multiple computing environments 1110. For example, unless otherwise noted herein, one or more of instructions or data stored on the memory 1120 may be stored partially or entirely in a separate computing environment 1110 that is accessed over a network.

Referring to FIGS. 1-11 generally, it is noted that the present disclosure has a number of advantages relative to existing multivariate testing systems. For example, the cross-channel features of the present disclosure allow for tracking of users across channels to ensure that individual users are not double-counted in analysis if those users engage with the retailer along a plurality of channels. This can be accomplished by using user identifiers at the time of assignment of tests to user populations. Additionally, self-service definition of tests allow users improved freedom to define analyses that are desired. Additionally, automated analysis of tests, and centralized management improves dissemination of learnings throughout an organization more efficiently.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and methods to the particular aspects described. Accordingly, additional configurations can be used to practice the methods and systems herein and/or some aspects described can be excluded without departing from the methods and systems disclosed herein.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A multivariate testing platform comprising:
a test definition environment including a test deployment and data collection interface configured to:
manage test deployments within a retail environment to a controlled subset of users across a plurality of content delivery channels; and
receive test data from an analytics server regarding user interaction regarding the test deployment,
wherein the test definition environment includes a self-service test definition and analysis tool configured to generate a user interface accessible by enterprise users, the user interface including a test definition interface useable to define a test selectable from among a plurality of test types and an analysis interface graphically displaying test results based on the test data from the analytics server, the test results attributing at least a portion of sales lift to two or more content delivery channels and being associated with a set of test subjects, the test subjects tracked across the two or more content delivery channels.

2. The multivariate testing platform of claim 1, further comprising a streaming data ingestion engine configured to receive the test data from the analytics server.

3. The multivariate testing platform of claim 2, further comprising a metadata enrichment subsystem receiving the test data from the web traffic ingestion engine and applying metadata descriptive of one or more attributes of the test data.

4. The multivariate testing platform of claim 3, further comprising a metrics processing engine configured to generate a plurality of metrics based on enriched test data.

5. The multivariate testing platform of claim 1, further comprising a data storage system configured to store enriched test data received from the metadata enrichment subsystem and metrics generated by the metrics processing engine.

6. The multivariate testing platform of claim 2, wherein the test data comprises web traffic associated with a test deployment, the test deployment defining a test group and a control group.

7. The multivariate testing platform of claim 1, wherein the plurality of test types includes one or more of: a pre/post test, an event test, a session test, a visitor test, a known user tests, a targeted audience test, or a geographic region-specific test.

8. The multivariate testing platform of claim 1, wherein the test definition environment is communicatively connected to a retail environment including an online retail environment and a point of sale environment, the test definition environment configured to deploy a test to at least one of the online retail environment or the point of sale environment and receive traffic information from the analytics server responsive to the test.

9. The multivariate testing platform of claim 1, wherein the test definition environment manages a test deployment across a plurality of test deployment stages.

10. The multivariate testing platform of claim 9, wherein the plurality of test deployment stages include a proposed test stage, an approved test stage, a live test stage, a completed test stage, and an archived test stage.

11. The multivariate testing platform of claim 1, wherein the analysis interface graphically displays test results associated with one or more selected channels of the plurality of content delivery channels.

12. The multivariate testing platform of claim 11, wherein the one or more selected channels includes at least one channel that is different from a channel associated with the test deployment.

13. A method of executing a multivariate test within a retail environment, the method comprising:
receiving, from a first user, a definition of a proposed test via a self-service test definition and analysis tool of a multivariate testing platform, the definition of the proposed test including a proposed change to one or more of: a product offering, a product display, an advertisement, or a digital content distribution, the definition including a selection of a duration and one or more content delivery channels from among a plurality of available content delivery channels;
upon acceptance of the proposed test, activating the proposed test for the duration by providing the proposed change to a test group and withholding the proposed change from a control group, wherein the activated proposed test is provided in realtime within current retailer commercial offerings; and
generating a graphical illustration accessible by the first user via the self-service test definition and analysis tool of test results, the test results attributing at least a portion of sales lift to two or more content delivery channels and being associated with a set of test subjects, the test subjects tracked across the two or more content delivery channels.

14. The method of claim 13, further comprising receiving an acceptance of the proposed test from a second user, the second user having different access rights within the multivariate testing platform as compared to the first user.

15. The method of claim 13, wherein the graphical illustration is accessible by the first user upon completion of the duration of activation of the proposed test.

16. The method of claim 13, wherein the proposed change comprises a change to a product offering on a retail website, and wherein the test results are generated based on information gathered from a web analytics platform associated with the retail website.

17. The method of claim 13, wherein the definition includes a selection of a proportion of a user group as the test group.

18. The method of claim 13, wherein the graphical illustration depicts one or more confidence intervals indicating a confidence metric, the confidence metric representing an extent to which a difference between behavior of the test group and the control group is attributable to the proposed change.

19. The method of claim 13, further comprising receiving the test results from an analytics server configured to track user behavior across two or more of the plurality of available content delivery channels.

20. The method of claim 13, further comprising discarding one or more outliers from the test results based on observed unpredicted behavior.

21. The method of claim 14, further comprising activating a plurality of proposed tests concurrently, each of the plurality of proposed tests having a test group that is at least partially different from a test group of others of the plurality of proposed tests.
